(19) United States
(12) Patent Application Publication
(10) Pub. No.: US 2016/0180046 A1
(43) Pub. Date: Jun. 23, 2016

(54) DEVICE FOR INTERMEDIATE-FREE CENTRALISED CONTROL OF REMOTE MEDICAL APPARATUSES, WITH OR WITHOUT CONTACT

(71) Applicant: UNIVERSITE PIERRE ET MARIE CURIE, Paris (FR)

(72) Inventors: Alain SEZEUR, CACHAN (FR); Jean-Francois OMHOVER, MAISONS-ALFORT (FR); Vincent MEYRUEIS, PARIS (FR)

(21) Appl. No.: 14/908,784

(22) PCT Filed: Aug. 1, 2014
(86) PCT No.: PCT/FR2014/052018

§ 371 Date: Jan. 29, 2016

(30) Foreign Application Priority Data
Aug. 1, 2013 (FR) 13 57677

(51) Int. Cl. G06F 19/00; G06F 3/0482; G06F 3/01; G06F 3/0484; G05B 15/02; G09G 3/00

(52) U.S. Cl. CPC G06F 19/3418; G05B 15/02; G09G 3/002; G06F 3/017; G06F 3/04842; G06F 3/0482

(57) ABSTRACT

A device (1) for the remote control, with or without contact, of at least one medical apparatus (2), including a device (5) for projecting a graphical user interface (8) onto at least one receiving surface (9), an object tracking device (6) for detecting a movement of at least one object (10) in at least one capturing area (11), and a device (7) for communicating with at least one medical apparatus (2) in order to transmit a predefined command to the at least one medical apparatus upon detection of the movement. The at least one receiving surface (9) is a physical surface separating a first working area (100) from a second working area (200), the first working area (100) including at least one capturing area (11).

The present invention relates to a device for controlling medical apparatuses without physical contact, usable by a practitioner.

Conducting an operation requires the practitioner to use medical apparatuses, possibly surgical.

Numerous devices such as electrosurgical scalpels are indispensable instruments for conducting many surgical operations. The environment of an operating room must meet stringent hygiene requirements and strict sterility conditions. During an operation, the surgeon cannot have physical contact with the controls of surgical or exploration instruments.

In addition, certain delicate acts such as the destruction of a tumor cell are reliant on communication between surgeon and assistant. To adjust the various medical devices during the operation, the surgeon usually has to rely on an assistant to perform the necessary manipulations. Communication between surgeon and assistant is sometimes ambiguous and difficult, as indicated in the document “A non-contact mouse for surgeon computer interaction” by C. Graetzel, T. Fong, S. Grange, and C. Baur, published in Technology and Health Care, 12(3): 245-257, 2004.

Giving the surgeon autonomy in controlling the settings or activation of electronic devices in the operating room seems to be a real issue during an operation, as this frees the operator (surgeon or practitioner) of a dependency on a third party (nurse) to control the medical devices.

Also known are devices using touch screen displays, such as those discussed in the article “An Approach for Projector-based Surgeon-Computer Interaction Using Tracked Instruments” by Bojan Kocev, Darko Ojdani'c, and Heinz-Otto Peitgen, published in Fraunhofer MEVIS Universitat sallee 29, 28359 Bremen, Germany. Unfortunately, these devices do not allow ensuring 100% sterility (Kocev et al., 2011). This type of device must be supplemented with a sterile cover to limit the risk of contamination and requires the surgeon to turn away from the operating table to perform the necessary manipulations, as described for example in document U.S. Pat. No. 4,621,735, to avoid being hampered by an intervening aid or hardware.

Also known are other contact-free control devices with gesture recognition designed for the operating theater. Their features and uses, however, are more geared towards visualization of patient information and medical imaging during an operation, particularly through access to the Pictures Archiving and Communication Systems (PACS) network.

Thus, the abovementioned device proposed by Kocev et al., 2011, uses an optical measurement system to track the surgical tools which have an attached tracker and which are used to interact with the projected virtual interface. This system allows the surgeon to project the virtual interface into a sterile flat area of choice and thus view preoperative data or patient information. This device does not allow the surgeon to control the equipment in the operating room. Its use is therefore not to give autonomy to the surgeon, and the proposed functionalities require the installation of trackers, making it complex to use in a medical interventional environment.

Similarly, the abovementioned device proposed by Graetzel et al. in 2004 uses a stereo camera system for the recognition of hand movements, enabling a surgeon to make more effective use of the computers present in a medical interventional environment. This device provides the surgeon with the ability to determine a capture workspace within which the surgeon can control the computer through hand movements. To minimize the presence of screens, the device uses the endoscope video monitor. This device does not fully satisfy the constraints of a medical intervention. The surgeon must turn towards the stereoscopic column in order to view the information on the computer, and this device can only be used for a certain type of medical procedure requiring the presence of the stereoscopic column.

Patent application WO2012 129669 proposes a device for controlling electronic equipment in order to display medical information on a display system, for example an LCD monitor. This device uses a gesture recognition system such as Kinect® or WAVI Xtion® to control equipment enabling navigation of the PACS system. This device therefore requires the use of an LCD monitor, which is a constraint in an often already crowded interventional environment. In addition, this device does not allow controlling the equipment of an interventional environment, for example such as the operating table, the scalpel, or the operating theater light.

Patent application WO2011 85815 proposes a control device, for example one that detects movement of the hands or of an instrument, for controlling a navigation system in a medical environment. User gestures cause execution of a set of commands such as manipulating displayed images or controlling the software functions of a medical navigation system. This device proposes viewing the image on a monitor or projecting it on a suitable background. At no time does this device solve the problem of autonomy and sterility of the surgeon in adjusting equipment settings in a surgical environment. There is therefore a need for a device providing the surgeon with direct control, without any intermediate person, of some or all of the electronically controlled equipment in the operating theater or procedure room, with no risk of non-sterile physical contact with any element whatsoever, thus solving the problems of the devices discussed above.

The present invention therefore aims to remedy these disadvantages by proposing a control device with no physical contact between the practitioner and the control of his or her instruments, and without necessarily requiring involvement of a third party.

To this end, the invention relates to a device for the remote control, with or without contact, of at least one medical apparatus, comprising:
at least one device for projecting a graphical user interface onto at least one receiving surface,
at least one object tracking device for detecting a movement of at least one object in at least one capturing area, and
at least one device for communicating with at least one medical apparatus, in order to transmit, upon detection of said movement, a predefined command to said at least one medical apparatus.

The device is furthermore such that the at least one receiving surface is a physical surface separating a first working area from a second working area, the first working area including at least one capturing area.

“Medical apparatus” is understood to mean any electronic device capable of being used in a medical environment, for bringing about a change in the physical condition of a patient according to a predefined command of an operator, or for an exploration performed by a medical practitioner, such as an endoscopic exploration, or for accessing and displaying a patient file on the receiving surface in order to obtain information (history, medical issues, allergies . . . ). In general, “bringing about a change the physical condition of a patient” is understood to mean any change in the function or physical condition of a patient, including, by way of non-limiting example, the use of electrocautery to open the patient's body, cut or cauterize tissue, destroy cells, especially tumor cells, or inflate the patient's abdomen with gas in order to perform a laparoscopy, this list obviously not being exhaustive and only given as an indication. Advantageously, the medical apparatuses are surgical medical devices.

The term “projection device” is understood to mean a device capable of projecting existing information onto a defined surface. The device may in particular be equipped with means for enlarging the image to be projected. Thus, preferably, the projection device is a video projector. Generally equipped with an objective lens part, it may be equipped with various optical systems to allow adapting the projected information to the distance between the projection device and the screen, or adapting the image to the color of the projection surface, in order to optimize the contrast and visual appearance. In addition, the projection device may be adapted for use in a sterile room, and in particular, said device may not include a fan. The control device may be equipped with several projection devices. The projection device may be equipped with sensors that allow adapting the device to the receiving surface. The device may be secured to a fastening means integral to the receiving surface, or may be set apart on another surface such as the wall or ceiling of an operating room for example.

“Graphical user interface” (GUI) is understood to mean the interface enabling easy man/machine interaction, represented in graphical form, in which all commands for the instruments that the user can manipulate are represented as icons or diagrams.

The term “receiving surface” is understood to mean the surface on which the graphical user interface is projected. This surface may separate a first working area from a second working area, for example in order to isolate the practitioner.

“Working area” is understood in general to mean an area of the operating room in which the surgeon and/or the surgeon's assistants can move about and/or in which medical apparatuses or objects can be arranged. A working area may or may not be sterile and may or may not be used during a particular procedure depending on its location in the operating room.

The first working area and second working area may be distinct. The second working area may, for example, be used as space for the anesthetist in the non-limiting case of a surgical procedure. Advantageously, the receiving surface is close to the practitioner, at a distance of less than 2 meters, and more preferably at a distance of less than 1.50 meters. If the control device is equipped with multiple projection systems, there may be multiple receiving surfaces. The projection surface may be of any type and, advantageously, the receiving surface is a sterile drape used during surgical procedures. Sterile drape is understood to mean a cloth which, once placed in the area of medical intervention, in particular during operations (for example general surgery, visceral surgery, veterinary surgery, but also in interventional radiology in the broad sense, or during endoscopies . . . ), defines a sterile space in the area of medical intervention. For example, this drape is non-woven, and typically it is hung substantially perpendicular to a recumbent patient and generally isolates the surgeon's work area from that of the anesthetist. The sterile drape may have adhesive edges and may be transparent or semi-transparent. The receiving surface defines two distinct areas; generally, at least one of the two areas is sterile.

“Object tracking device” is understood to mean the device capable of detecting the position and/or movement of objects in the space defined by the capturing area and the receiving surface. The detected object could be the instrument itself, but could also be the surgeon's hand. The technology used for the object tracking system may be a type of “leap-motion” technology, using optical sensors, a “Kinect” system, or any other system using the principles of stereoscopy or object tracking.

“Capturing area” is understood to mean the area where the object tracking takes place. This capturing area, defined as the active area in which the receiving surface is placed, is preferably located near the practitioner and in particular at a distance of less than 2 meters, and preferably at a distance of less than 1.50 meters. This capturing area advantageously defines where to place the receiving surface.

“Communication device” is understood to mean the device enabling interconnection of the equipment, for example in the operating theater, but also enabling their control. The device may be wired or wireless, and advantageously said device communicates via power-line communication.

“Third party” is understood to mean any person who is not the person performing the medical procedure, whether surgical or non-surgical. For example, the third party may be the anesthetist during a surgical operation.

In preferred embodiments of the invention, one or more of the following arrangements may possibly be used:
the receiving surface is a flexible surface, and in particular a sterile drape;
the receiving surface is immediately adjacent to an operating area of an operating room, preferably at a distance of less than 2 meters, even more preferably at a distance of less than 1.5 meters;
the projection device is a video projector and more particularly a cold light video projector;
the receiving surface and the projection device are not in contact with each other;
the capturing area is immediately adjacent to an operating area of an operating theater and has a maximum dimension of less than 2 meters, preferably a maximum dimension of less than 1.5 meters;
the communication device is able to communicate with the medical apparatus by means of a power-line communication link;
the communication device is able to communicate with the surgical medical apparatus by means of a wireless link;
the communication device is able to communicate with at least two medical apparatuses, the object tracking device is able to detect at least two distinct movements of said at least one object in the capturing area, and the communication device is able to transmit, upon detection of said at least two movements, at least two respective predefined commands, respectively to said at least two medical apparatuses.

The invention also relates to a method for the remote control, with or without contact, of at least one medical apparatus, wherein:
a graphical user interface is projected from a distance onto at least one receiving surface by means of at least one projection device, the receiving surface being a physical surface separating a first working area from a second working area,
a movement of at least one object is detected in at least one capturing area within the first working area, by means of at least one object tracking device, and
upon detection of said movement, a predefined command is transmitted to said at least one medical apparatus by means of a communication device.

In preferred embodiments of the invention, one or more of the following arrangements may possibly be used:
during an initialization step, a spatial position of at least one point of the receiving surface is detected, and at least one geometric correction coefficient is defined for the graphical user interface and/or the capturing area based on said spatial position;
during an initialization step, a color of at least one point of the receiving surface is detected, and at least one color correction coefficient is defined for the graphical user interface based on said color;
a predefined command is prevented from being sent to the medical apparatus as long as an operator has not confirmed a checklist;
the checklist is projected from a distance onto the receiving surface, by the projection device;
the checklist includes a plurality of checklist items and, in order to confirm each of said checklist items, at least one movement of said at least one object is detected in the capturing area by means of the object tracking device.

The invention will be better understood from the following detailed description, with reference to the accompanying schematic drawings in which:

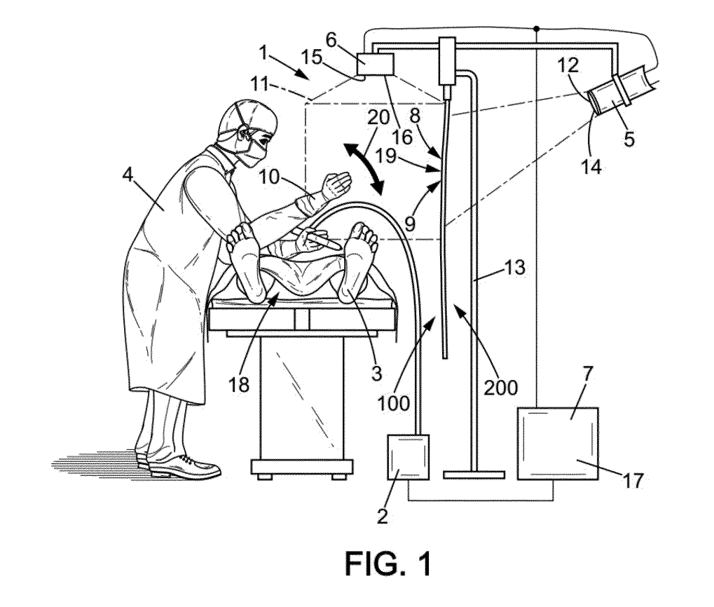

FIG. 1 illustrates a device for the remote control, with or without contact, of at least one medical apparatus according to an embodiment of the invention.

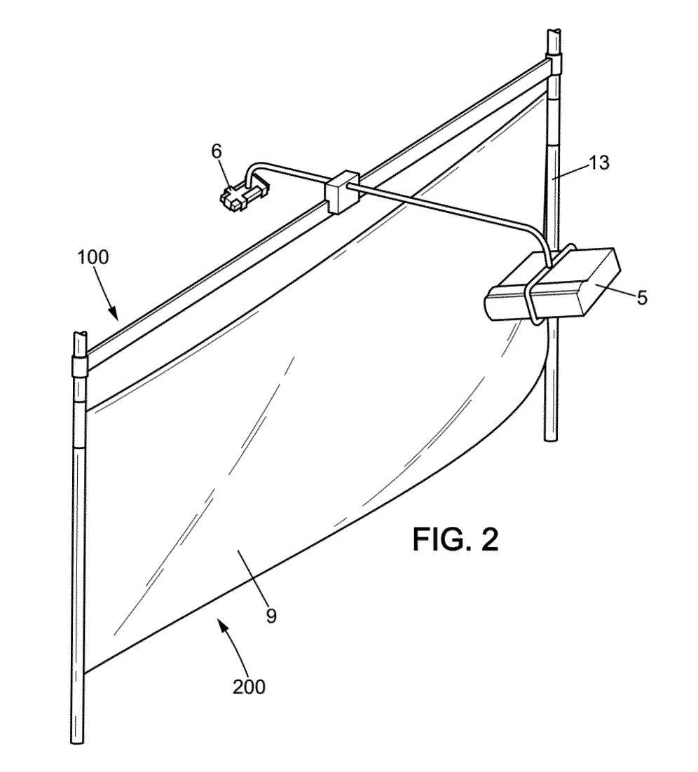

FIG. 2 illustrates details of the control device of FIG. 1.

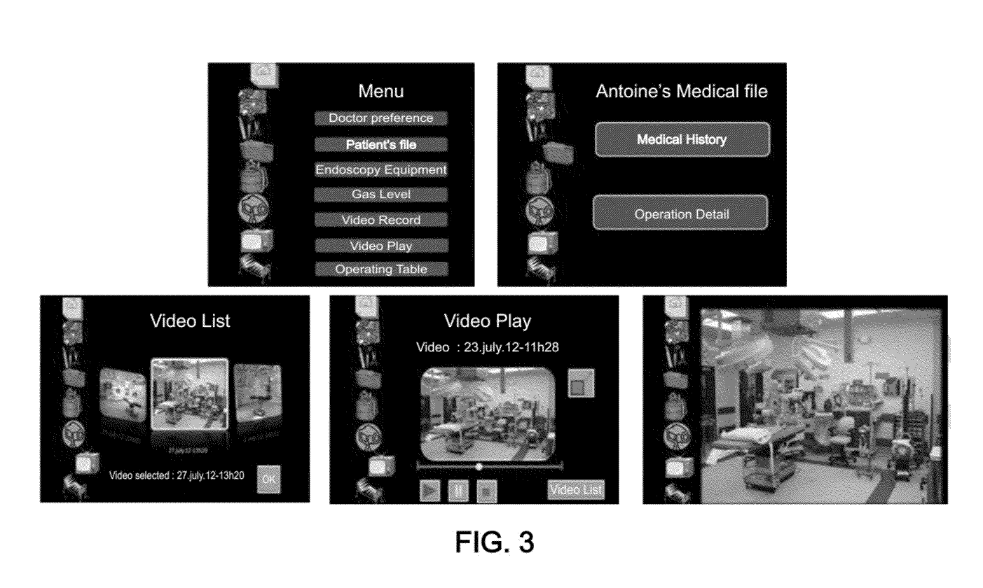

FIG. 3 illustrates a graphical user interface in one embodiment of the control device of FIG. 1.

The embodiments described below are in no way limiting; one may consider variants of the invention which comprise only a selection of the described characteristics, subsequently isolated from other described characteristics (even if this selection is isolated within a sentence containing these other characteristics), if this selection of characteristics is sufficient to provide a technical advantage or to differentiate the invention from the prior art. This selection comprises at least one characteristic, preferably functional without structural details, or with only a portion of the structural details if this portion is sufficient to provide a technical advantage or to differentiate the invention from the prior art.

FIGS. 1 and 2 illustrate a control device 1 at a distance from a surgical medical apparatus 2 of an operating theater according to the invention. The device 1 is intended specifically for remotely controlling a surgical medical apparatus 2 capable of being used to bring about a change in the physical condition of a patient 3. The change in the physical condition of the patient 3 is achieved by the surgical medical apparatus 2 in accordance with a predefined command from an operator 4. The operator 4 may in particular be a surgeon responsible for performing a surgical procedure on the patient 3.

As illustrated in FIG. 1, the control device 1 comprises a projection device 5, an object tracking device 6, and a communication device 7. These may be functionally organized as follows.

The projection device 5 projects a graphical user interface 8 from a distance onto a receiving surface 9.

The object tracking device 6 detects a movement of an object 10 in a capturing area 11. The object 10 is further detailed below, but may, for example, be a surgeon's hand. The movement of the object 10 is for example illustrated by the arrow 20 in the figures.

Upon detection of said movement, the communication device 7 transmits a predefined command to the surgical medical apparatus in the operating theater 2.

More specifically, in one embodiment of the invention, the projection device 5 projects, across the capturing area 11 defined by the device, a graphical user interface 8 allowing the surgeon to interact with his or her instruments, in other words with the surgical medical apparatus 2 in the non-limiting case of a surgical operation.

In one embodiment, the receiving surface 9 is immediately adjacent to an operating area 18 of the operating theater, preferably at a distance of less than 2 meters, even more preferably at a distance of less than 1.5 meters. In this manner, the operator 4, in particular the surgeon, can remain standing in the operating area and observe the graphical user interface 8 without moving.

The projection surface 9 may separate a first working area 100 from a second working area 200.

The working areas 100, 200 are sterile or non-sterile areas of the operating room where the surgeon and/or the surgeon's assistants can move about and/or in which medical apparatuses or objects may be arranged. A working area may or may not be used during a particular operation depending on its location in the operating room. The first working area 100 may in particular include the capturing area 11.

In one embodiment, the receiving surface 9 is a flexible surface. The receiving surface 9 may in particular be a sterile drape. Alternatively, the receiving surface 9 may be a rigid tray, for example a tray immediately adjacent to an operating area 18, such as a sterile tray.

Generally, the receiving surface 9 and the projection device 5 are not in contact. This easily ensures sterility of the receiving surface 9 when such sterility is needed.

In a particular embodiment of the invention, the projection device 5 is a video projector, attached for example to a gallows as illustrated in FIG. 1. The portion 12 constituting the video projector objective may be equipped with an optical system in the broad sense, which allows adapting the projection of the graphical user interface 8 on the receiving surface 9, particularly the sterile drape. In the exemplary case where the sterile drape 9 is fixed to an arm or a moving gantry 13, this embodiment allows equipping the objective 12 with one or more lenses, or with any optical system enabling control of the focusing of the projected graphical user interface 8, so as to adjust the focus of the video projector 5 or to correct image distortion by optical, electronic, or software means. In the same spirit, it will be obvious that the objective 12 of the video projector 5 may comprise any optical system that allows zooming in or out on the displayed graphical user interface 8. In another embodiment of the invention, the objective 12 may be equipped with color filters in the broad sense, for adapting the color of the graphical user interface 8 to the color of the receiving surface 9 on which the graphical user interface 8 is projected, in particular the sterile drape, in order to optimize the visual contrast and improve the ease of viewing by the operator, in particular the surgeon.

In yet another embodiment, the graphical user interface 8 may be projected by a projection device 5 using laser scanning. For example, the PicoP Microvision system may be used to project information. Such a projection device 5 may in particular be afocal. In this manner, the surgeon will not need to adjust the focus of the projector 5, particularly if there is movement of the receiving surface 9, in particular the sterile drape. The operator can therefore remain focused on the procedure.

In another embodiment, the objective 12 of the projection device 5 may be equipped with one or more filters, for example polarized or with active shutters, to allow projecting 3D information in the capturing area 11. The surgeon could wear glasses for viewing this 3D information.

In a preferred embodiment of the invention, the projector 5 does not include a fan and may comprise at least one cold light source such as a light emitting diode (LED), improving the quality of a sterile interventional environment such as an operating theater.

In a preferred embodiment of the invention, the projection device 5 is located on the side opposite to the sterile medical intervention area or operating area, with respect to the receiving surface 9, in particular the sterile drape, and projects a graphical user interface 8 that is at least partially reversed. A user, for example a surgeon, and another user, for example the anesthetist, can thus each have their own respective graphical user interface.

In one particular embodiment of the invention, the projection device 5 is equipped with one or more sensors 14, for example enabling measurement of the position of the receiving surface 9, in particular the sterile drape, or detection of the shape of the receiving surface 9, in particular the sterile drape. In this manner it is possible to ensure optimum viewing of the interface 8 and the projected information by adapting the image projection device 5 to deformation of the projection area. For example, one can use a computer program that will correct and/or adjust the projection device 5, such as the Projection Mapping technique.

For example, during a step of initializing the system and the control method, one can detect the spatial position of one or more points of the receiving surface 9, in particular by means of the sensor 14. This spatial position is detected for example with respect to the projection device 5. Next, one can define at least one geometric model of a geometric correction coefficient for the graphical user interface 9 as a function of said one or more spatial positions. It is thus possible to calibrate, for example, the position of the fingers or the location of the projection area.

In addition, during said initialization step, the color of one or of a plurality of points of the receiving surface 9 can be detected, in particular using the sensor 14. One can then define at least one color correction coefficient for the graphical user interface 9 as a function of said color.

In one particular embodiment, the sensor 14 may be located on the projector 5 side relative to the receiving surface 9, or the sterile side, in order to measure and control the light intensity on the drape. The user can adjust the lamp power of the video projector according to the ambient lighting.

Advantageously, the system comprises two sensors 14 located one on either side of the receiving surface 9, in particular of the sterile drape.

The graphical user interface 8 of this invention is defined as being any system that allows for example a man/machine interaction, in which the objects to be manipulated are typically represented as specific icons for each medical device, mimicking the physical manipulation of these objects with an aiming system. An example graphical representation of the graphical user interface is given in FIG. 3.

The object tracking device 6 allows detecting the position and/or movement of an object 10 in space. This detection defines a capturing area 11, within which the surgeon 4 can perform control gestures. In one particular embodiment of the invention, the receiving surface is a sterile drape. Thus the user, for example the surgeon, can use this receiving surface to give a command without consequences on the subsequent course of the operation, as opposed to using an LCD screen where a simple contact between surgeon and screen requires temporarily halting the operation in order to change the now non-sterile gloves of the practitioner. This device allows determining the position of the surgeon's hands and defining their movements. Thus a specific action of a medical and/or surgical device bringing about a change in the physical state of a patient for example can be assigned to a certain gesture, while maintaining the conditions of sterility for the surgeon in a medical interventional environment.

The capturing area 11 is, for example, immediately adjacent to the operating area of the operating room. The capturing area 11 has, for example, a maximum dimension of less than 2 meters, preferably a maximum dimension of less than 1.5 meters, in order to allow the operator to cover it completely with arm movements only, in particular without requiring the operator 4 to change location.

Typically, the object tracking device 6 comprises at least one sensor 15 and is possibly supplemented with one or more transmitters 16.

In one particular embodiment of the invention, these sensors 15 are based on optical sensors, working for example in the visible or IR wavelength. The sensors 15 are, for example, an optical or infrared camera.

In one particular embodiment of the invention, the object tracking device 6 uses “Leap Motion” technology. This technology, consisting of a trio of infrared lights 16 and two optical sensors 15, illuminates the scene via an IR transmitter. The sensors 15 capture the light intensity reflected by the objects 10.

It is obvious and easily understood by the skilled person that the invention is not limited to this type of technology for tracking objects. In one particular embodiment, the “Kinect” system can be used, as can the “WAVI Xtion” system (ASUS) or any other system using the principle of object tracking or stereoscopy.

The objects 10 include, for example, the hands, fingers, and/or forearm of the surgeon, or the medical intervention instruments.

The position of the hands, fingers, and/or forearm of the surgeon can therefore be detected, as can the medical intervention instruments, without requiring that a sensor be worn by the surgeon.

The control system 1 may comprise at least one configuration means for calibrating the projection of the graphical user interface 9 relative to the object tracking device 6 and to the position of the receiving surface 8, in particular the sterile drape. This configuration means, comprising mechanical elements or comprising software processing elements or comprising mechanical and software processing elements, allows in particular, by changing the angle of inclination of the object tracking device 6, changing the capturing area 11 according to user needs by confining this space of limited volume relative to the capacity of the object tracking device 6. The configuration means 6 of the tracking device may also be automated using motor means.

Thus, similarly to what has been described above concerning the projection device 5, during an initialization step, one can detect a spatial position of at least one point of the receiving surface 9, for example the spatial position relative to the projection device 5 or to the object tracking device 6. One can then define at least one geometric correction coefficient for the capturing area 11 based on said spatial position of at least one point of the receiving surface 9.

Without limitation, the various possible commands for surgical medical devices are for example:
controlling the power intensity of the electrosurgical scalpel or of any hemostatic medical apparatus
controlling electrocoagulation modes (bipolar, monopolar . . . )
controlling the position of the operating table
controlling a tumor destruction system (for example ultrasound power, radiofrequency, etc.)
controlling various hardware on a laparoscopy column (insufflator, camera, cold light, etc.)

In some particular embodiments, the system may further allow controlling other devices and elements of the operating theater, including:
controlling the intraoperative imaging system (for example ultrasound, etc.)
triggering the capture and display of video, patient records (radiology, history, etc.)
controlling the positioning or intensity of the operating theater light.

These commands are integrated into a graphical user interface 8 ergonomically adapted to the projection and interaction device (button size, colors, sequences, etc.). Indeed, as surgical drapes are generally blue or green, the choice of colors in the interface should allow optimizing the appearance of the interface colors on the drape, for example using the colors opposite blue and green on the color wheel. The drape is then a background suitable for projection of the graphical user interface 8 as detailed above.

The capturing area 11 created by the projection device 5 may define the location where the graphical user interface 8 will be projected. Typically, this capturing area 11 is delimited on at least one end by the passive receiving surface 9, in particular a sterile drape.

“Sterile drape” is understood to mean a cloth which, once placed in the area of medical intervention, in particular during operations (for example general surgery, visceral surgery, veterinary surgery, but also in interventional radiology in the broad sense, or during endoscopies . . . ), defines a sterile space in the area of medical intervention. For example, this drape is non-woven, and typically it is hung substantially perpendicular to a recumbent patient and generally isolates the surgeon's work area from that of the anesthetist. The sterile drape may have adhesive edges and may be transparent or semi-transparent. Generally, it is attached to at least one bracket by means of a hanging system. In one particular embodiment of the invention, the sterile drape may be attached to a horizontal or vertical bar, said bar being mounted on the operating table or directly on the floor.

In one particular embodiment of the invention, the drape could be held on a movable arm, allowing it to be moved about easily. In addition, the projection system/capturing area assembly may be secured to an arm mounted for example on the wall or ceiling. Thus, the assembly could be located on each side of the surgical drape.

Of course, it is easy to understand that the receiving surface 9 onto which the graphical user interface 8 is projected will not necessarily be sterile. The invention can be used for example, in one particular embodiment, for endoscopic examinations where the sterility of the operating room or examination room is not a requirement.

A data processing system 17 allows determining the positions of an object 10 and defining its movement. This system may be embedded in at least one of the devices of system 1 or remote from it. It may also be embedded in an installed processing unit and may in particular be integrated into the object tracking device 6 or projection device 5. Typically it can be a processor, a computer, or a tablet. “Data processing system” is understood to mean any system which allows modeling, by any means whatsoever, the position and/or movement of an object in space in relation to the projected graphical user interface, and defining an aiming system.

The command transfer and communication device 7 allows interconnecting with the operating room equipment and controlling them. Such a device may send a signal to the electronically controlled medical devices in the medical interventional environment, for example in order to control the position of the operating table. “Command transfer and communication device” 7 is understood to mean any device enabling, for example, interaction with and control of the functions of medical surgical apparatuses in the medical interventional environment, databases, the connected network.

The control system 1 according to the invention thus makes it possible in particular to use, in a medical interventional environment, a virtual interface projected onto a sterile drape which generally separates the surgeon's working area (sterile) from that of the anesthetists and prevents the doctor from the risk of contamination and therefore having to change the now non-sterile gloves when issuing commands to the medical equipment. The sterile drape is typically put in place at the beginning of the operation and is usually held by a fastening system such as a set of brackets.

Furthermore, the device may be equipped with a voice control system. In this particular embodiment of the invention, the voice control system allows the surgeon to switch the device on and/or off and/or place it on standby. In addition to this particular embodiment, the device may include a sound reproduction system. The surgeon will then have the certainty, without requiring visual verification, that the command just issued has been acknowledged by the device. He or she can thus use the equipment with full confidence.

In addition, the various systems of the device can communicate with each other and/or with the equipment of the medical interventional environment by a wired or wireless system, for example using WiFi or Bluetooth technology. In a preferred embodiment of the invention, the various systems of the device can communicate with each other, and/or with the equipment of the interventional medical environment, by a power-line communication (PLC) system.

In particular the communication device 7 may be able to communicate with the surgical medical apparatuses 2 of an operating theater by means of a power-line communication.

This technique put forward here, consisting of building an inexpensive, reliable computer network that consumes few resources, is ideal for integrated and highly automated management of all the instruments.

Alternatively, the various systems of the device may communicate with each other and/or with the equipment of the medical interventional environment by wireless connections. Thus, the communication device 7 may be able to communicate with the surgical medical apparatuses 2 of the operating theater by means of a wireless link.

Finally, the device may receive power by any means, in particular from the power grid or from a battery or batteries. In one particular embodiment where there is a power cord system, the interconnecting cords are preferably integrated with the fastening system of the sterile drape, to minimize the cords running across the operating room.

The system 1 according to the invention may in particular be implemented in a method for the remote control of a surgical medical apparatus 2 of an operating theater, as will now be described. Such a method may in particular be intended specifically for the remote control of a surgical medical device 2 able to bring about a change in the physical condition of a patient 3 according to a predefined command from an operator 4.

In such a method according to the invention, implemented by means of a control device 1 according to the invention:
a graphical user interface 8 is projected from a distance onto a receiving surface 9 by means of a projection device 5,
a movement of at least one object 10 is detected in a capturing area 11 by means of an object tracking device 6, and
upon detection of said movement, a predetermined command is transmitted to the surgical medical apparatus 2 of an operating theater by means of a communication device 7.

In one particular embodiment, the transmission of a predefined command to the surgical medical apparatus 2 of an operating room by means of the communication device 7 may be prevented as long as an operator 4 has not confirmed a checklist.

The control system can only be active with the various medical apparatuses after confirmation of a checklist of data intended to ensure the safety of the surgical procedure.

The checklist may, for example, be displayed on the receiving surface 9, in particular by being displayed in the graphical user interface 8 projected from a distance by the projection device 4.

The checklist is, for example, a list containing a plurality of checklist items. The term “checklist items” is understood to mean items that the operator 4, in particular the surgeon or an assistant, must check in order to satisfy requirements, possibly legal (so-called pilot's checklist) before conducting the procedure. In one particular embodiment of the invention, to verify said checklist items, at least one movement of the object 10 is detected in the capturing area 11 by means of the object tracking device 6, for example a gesture made by the surgeon's hand indicating that a checklist item in the checklist has been verified.

1-15. (canceled)

16. A device for the remote control, with or without contact, of at least one medical apparatus, comprising:
at least one projection device for projecting a graphical user interface onto at least one receiving surface,
at least one object tracking device for detecting a movement of at least one object in at least one capturing area, and
at least one device for communicating with at least one medical apparatus, in order to transmit, upon detection of said movement, a predefined command to said at least one medical apparatus,
wherein the at least one receiving surface is a physical surface separating a first working area from a second working area, the first working area including at least one capturing area,
in that the capturing area is immediately adjacent to an operating area of an operating theater,
and in that the projection device is located on the side opposite to said operating area of an operating room, with respect to the receiving surface, and projects a graphical user interface that is at least partially reversed.

17. The control device according to claim 16, wherein the receiving surface is immediately adjacent to the operating area of an operating room, preferably at a distance of less than 2 meters, even more preferably at a distance of less than 1.5 meters, in particular wherein the capturing area is delimited on at least one end by the receiving surface.

18. The control device according to claim 16, wherein the capturing area is at a distance of less than 2 meters and preferably at a distance of less than 1.50 meters from the operating area of an operating theater, and has a maximum dimension of less than 2 meters, preferably a maximum dimension of less than 1.5 m.

19. The control device according to claim 16, wherein at least one of the two working areas defined by the receiving surface is sterile.

20. The control device according to claim 16, wherein the receiving surface is a sterile drape.

21. The control device according to claim 20, wherein the sterile drape is hung substantially perpendicularly to a recumbent patient.

22. The control device according to claim 20, wherein the sterile drape is transparent or semi-transparent.

23. The control device according to claim 16, wherein the sterile drape is attached to a horizontal or vertical bar mounted on an operating table or directly on the floor, or wherein the sterile drape is held on a movable arm, allowing it to be moved about easily.

24. The control device according to claim 16, wherein the sterile drape separates space for the surgeon from space for an anesthetist, the second working area serving as space for the anesthetist, in particular wherein a user such as a surgeon, and another user such as the anesthetist, each have their own respective graphical user interface.

25. The control device according to claim 16, wherein the communication device is able to communicate with the medical apparatus by means of a power-line communication link.

26. A method for the remote control, with or without contact, of at least one medical apparatus, wherein:
a graphical user interface is projected from a distance onto at least one receiving surface by means of at least one projection device, the receiving surface being a physical surface separating a first working area from a second working area,
a movement of at least one object is detected in at least one capturing area within the first working area, by means of at least one object tracking device, and
upon detection of said movement, a predefined command is transmitted to said at least one medical apparatus by means of a communication device,
wherein the capturing area is immediately adjacent to an operating area of an operating theater,
and wherein the projection device is located on the side opposite to said operating area of an operating room, with respect to the receiving surface, and projects a graphical user interface that is at least partially reversed.

27. The method according to claim 26, wherein, during an initialization step, a spatial position of at least one point of the receiving surface is detected and at least one geometric correction coefficient is defined for the graphical user interface and/or for the capturing area based on said spatial position, and/or a color of at least one point of the receiving surface is detected and at least one color correction coefficient is defined for the graphical user interface based on said color.

28. The method according to claim 26, wherein a predefined command is prevented from being sent to the medical apparatus as long as an operator has not confirmed a checklist.

29. The method according to claim 28, wherein the checklist is projected from a distance by the projection device onto the receiving surface.

30. The method according to claim 28, wherein the checklist comprises a plurality of checklist items and wherein, in order to confirm each of said checklist items, at least one movement of said at least one object is detected in the capturing area by means of the object tracking device.
